(19) United States
(12) Patent Application Publication
(10) Pub. No.: US 2012/0306897 A1
(43) Pub. Date: Dec. 6, 2012

(54) CONTROL CIRCUIT FOR INTERLANE SKEW

(76) Inventors: Sandra Liu, Richmond Hill (CA); Eric W. Hu, New Market (CA); Chih-Tsung Ku, Thornhill (CA)

(21) Appl. No.: 13/118,636

(22) Filed: May 31, 2011

(51) Int. Cl. H04L 25/02; G06F 13/14

(52) U.S. Cl. 345/520; 375/296

(57) ABSTRACT

A system for controlling signal skew between adjacent transmission lines is disclosed. In one embodiment, the system includes a plurality of transmission lines, each of which is physically adjacent to at least one other one of the plurality of transmission lines. The system further includes a plurality of transmission units, wherein each of the plurality of transmission units is coupled to a corresponding one of the plurality of transmission lines. Each of the plurality of transmission units is configured to transmit, in accordance with a respectively received one of a plurality of clock signals, a respective signal on its corresponding one of the plurality of transmission lines such that the respective signal is skewed by a predetermined amount with respect to signals transmitted on each adjacent one of the plurality of transmission lines.

### BACKGROUND

1. Field of the Invention

This invention relates to electronic circuits, and more particularly, to circuits for controlling the skew between signals transmitted along adjacent signal paths.

2. Description of the Related Art

Electromagnetic interference (EMI) is a condition associated with many electronic circuits. Electronic circuits may emit EMI in some cases, and may be affected by EMI in other cases. In some cases, electronic circuits may both be affected by EMI and may also emit EMI. In any case, the emission of EMI may cause undesirable affects, both to the circuit from which it is emitted as well as to those by which it is received.

Since EMI is undesirable, various techniques may be employed either to reduce its emission or to shield against its propagation. One method that may be used to reduce the emission of EMI is to utilize a spread spectrum clock in digital signal transmission. Instead of a clock signal operating at a single frequency, a spread spectrum clock may be varied over a range of frequencies. The clock signal may be used to synchronize one or more digital signals to be transmitted. Varying the clock frequency may spread any resulting EMI across a wider range of frequencies, thus reducing its impact at any one particular frequency.

### SUMMARY OF THE DISCLOSURE

A system for controlling signal skew between adjacent transmission lines is disclosed. In one embodiment, the system includes a plurality of transmission lines, each of which is physically adjacent to at least one other one of the plurality of transmission lines. The system further includes a plurality of transmission units, wherein each of the plurality of transmission units is coupled to a corresponding one of the plurality of transmission lines. Each of the plurality of transmission units is configured to transmit, in accordance with a respectively received one of a plurality of clock signals, a respective signal on its corresponding one of the plurality of transmission lines such that the respective signal is skewed by a predetermined amount with respect to signals transmitted on each adjacent one of the plurality of transmission lines.

In one embodiment, a method includes a plurality of transmission units transmitting signals on a plurality of transmission lines, wherein each of the plurality of signal lines is physically adjacent to at least one other one of the plurality of signal lines.

The plurality of transmission units includes a first transmission unit and a second transmission unit. The method further includes the first transmission unit transmitting, on a first one of the plurality of transmission lines, a first signal and the second transmission unit transmitting, on a second one of the plurality of transmission lines that is physically adjacent to the first one of the plurality of transmission lines, a second signal having a first predetermined amount of skew relative to the first signal.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a computer system including a graphics card and a display unit;

FIG. 2 is a block diagram of one embodiment of a transmission unit for a single channel;

FIG. 3 is a block diagram of one embodiment of a clock distribution apparatus for distributing clock signals to a number of transmission units;

FIG. 4 is a timing diagram illustrating the transmission of skewed signals on a number of physically adjacent channels for one embodiment of a system;

FIG. 5 is a flow diagram illustrating one embodiment of a method for transmitting signals having skew relative to those on adjacent channels; and

FIG. 6 is a block diagram of one embodiment of a carrier medium.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION

### Overview:

A system and method for controlling skew between physically adjacent transmission lines (e.g., signal paths) of a system is disclosed. The apparatus includes a number of transmission units, each of which is associated with one of a number of transmission lines. Each of the transmission lines may be physically adjacent to at least one other one of the transmission lines. A number of the transmission lines may be physically adjacent to multiple other ones of the transmission lines. As defined herein, a transmission line may be any type of signal path upon which signals are conveyed, including cables, wires, or circuit traces. Wireless transmissions from physically adjacent transmission units are also contemplated.

Each of the transmission units of the apparatus may receive a clock signal having a phase difference with respect to transmission units associated with physically adjacent transmission lines. For example, if two transmission lines are physically adjacent to one another, their respective transmission units may each receive a clock signal that differs in phase with respect to the other one of the transmission units. Data transmissions by a given transmission unit may be synchronized to the clock signal that it receives. Accordingly, data transmitted on a given transmission line may be skewed with respect to data transmitted on another transmission line. As used herein, the term ‘skew’ may be used to indicate a phase difference between two signals transmitted on different transmission lines. Furthermore, the term ‘skewed’, when used with respect to signals transmitted on different transmission line may indicate that logical transitions (e.g., logic 0 to logic 1) occur at different times with respect to one another. By skewing signals transmitted along adjacent transmission lines, electromagnetic interference (EMI) generated from such transmissions may be reduced. More particularly, since signal transitions occur at different times on adjacent transmission line, the generated electromagnetic energy resulting therefrom is spread out in time instead of being concentrated at a given instance.

Graphics Subsystem with Graphics Card and Display:

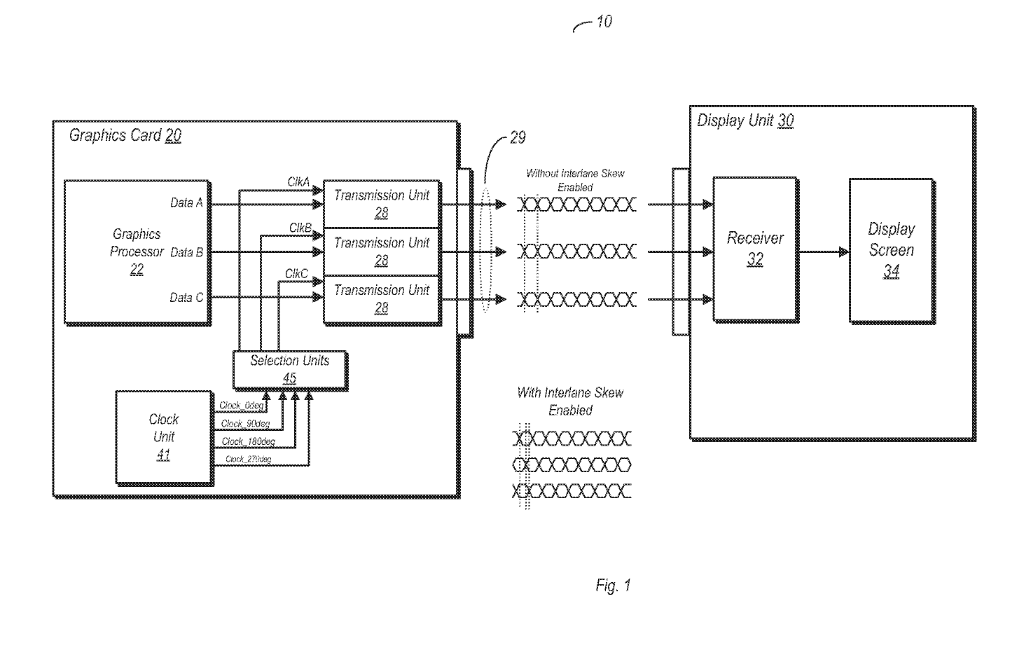

Turning now to FIG. 1, a block diagram illustrating one embodiment of a graphics subsystem is shown. In the embodiment shown, graphic subsystem 10 may be implemented in a computer system, a gaming system, or any other type of electronic system in which a graphic subsystem may be included. Graphic subsystem 10 as shown in FIG. 1 includes a graphics card 20 that is coupled to a display unit 30 via a number of transmission lines (e.g., signal paths) 29. As used herein, the term ‘transmission line’ may refer to any type of signal path (e.g., wired, wireless, or optical) that may be used to implement a communications channel. In this particular embodiment, transmission lines 29 may implement three different channels via signal paths in a video cable.

Display unit 30 in the embodiment shown includes a receiver 32 and a display screen 34. Signals transmitted from graphics cared 20 may be received via transmission lines 29 at receiver 32. The received signals may then be translated into information that may be sent to display screen 34 in order to render graphics and/or text for display. Display unit 30 may implement one of many different types of displays. Such display types may include plasma displays, liquid crystal displays (LCDs), light emitting diode (LED) displays, cathode ray tube (CRT) displays, and so forth.

Graphics card 22 in the embodiment shown includes a graphics processor 22 that may generate graphics information based on data received from other portions of the system in which it is implemented. The graphics information generated by graphics processor 22 may then be forwarded to transmission units 28. Each transmission unit 28 may transmit data signals in accordance with a clock signal received from a clock unit 41. Respective clock signals received by transmission units 28 that are associated with adjacent ones of transmission lines 29 may differ in phase with one another. Accordingly, signals transmitted onto adjacent ones of transmission lines 29 may be transmitted at different times with respect to each other.

In the embodiment shown, clock generator 41 configured to generate four different clock signals, each of which differs in phase with respect to the other clock signals. The generated clock signals include a 0° clock signal, a 90° clock signal, a 180° clock signal, and a 270° clock signals. Each of these clock signals may be provided to selection units 45. Clock signals may then be selected to the individual instances of transmission unit 28. The selection units may select clock signals for each transmission unit 28 such that each differs in phase from those received by the other transmission units 28. For example, ClkA could be the 0° clock signal, ClkB could be the 90° clock signal, and ClkC could be the 180° clock signal. Thus, in this example, signals transmitted from each of transmission units 28 are skewed with respect to signals transmitted from other ones of the transmission units. The amount of skew between two signals may be a predetermined amount based on the phase difference between respective clock signals. Using the example above, a logical transition transmitted in accordance with ClkB may be skewed by approximately 90° relative to a logical transition transmitted in accordance with ClkA. The generation and distribution of clock signals upon which the signal skew is based will be discussed in further detail below.

### Transmission Unit:

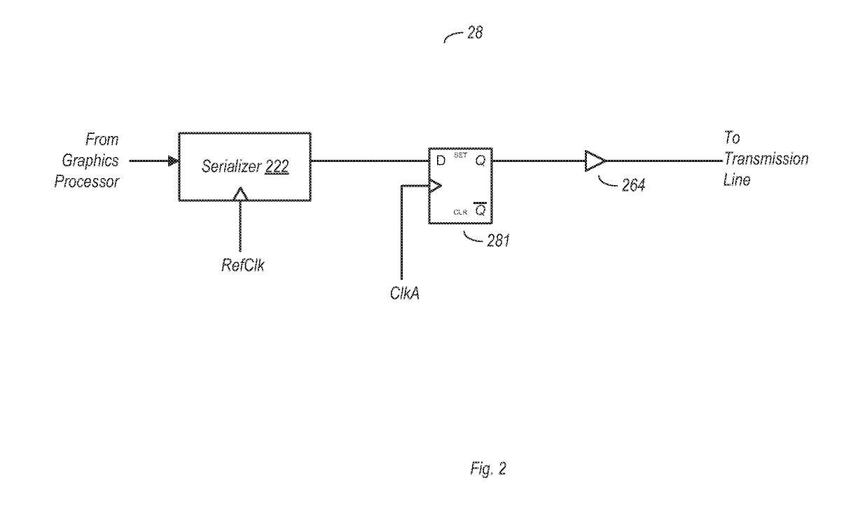

Turning now to FIG. 2, a block diagram of one embodiment of a transmission unit for a single channel is shown. In the embodiment shown, transmission unit 28 includes a serializer 222 that may be received data from graphics processor 22. In one embodiment, the data may be transmitted to serializer 222 in parallel, and may be converted therein into a serial stream of data bits. The transmission of bits of the serial stream may be synchronized to the reference clock that is received by serializer 222.

Each data bit of the serial stream may be received by flop circuit 281, implemented here as a D flip-flop. In the embodiment shown, flop circuit 281 is coupled to receive a clock signal, ClkA in this particular case. The received clock signal may have the same frequency as the reference clock signal, but may, in some cases, have a phase difference. In such cases where the reference clock and the received clock differ in phase, flop circuit 281 may introduce a predetermined amount of delay into the signal path. This amount of delay may be the basis for skewing a signal transmitted by flop circuit 281 with respect to signals transmitted by other instances of flop circuit 281. More particularly, when signals transmitted from two different instances of transmission unit 28 are delayed by different amounts, the difference in delay results in a skew between the signals.

In the embodiment shown, the output of flop circuit 281 is coupled to buffer 264, which may provide sufficient drive strength to convey the signal to a corresponding receiver. Embodiments with other types of circuitry coupled to the output of flop circuit 281, or no circuitry coupled thereto, are also possible and contemplated.

### Clock Distribution Apparatus:

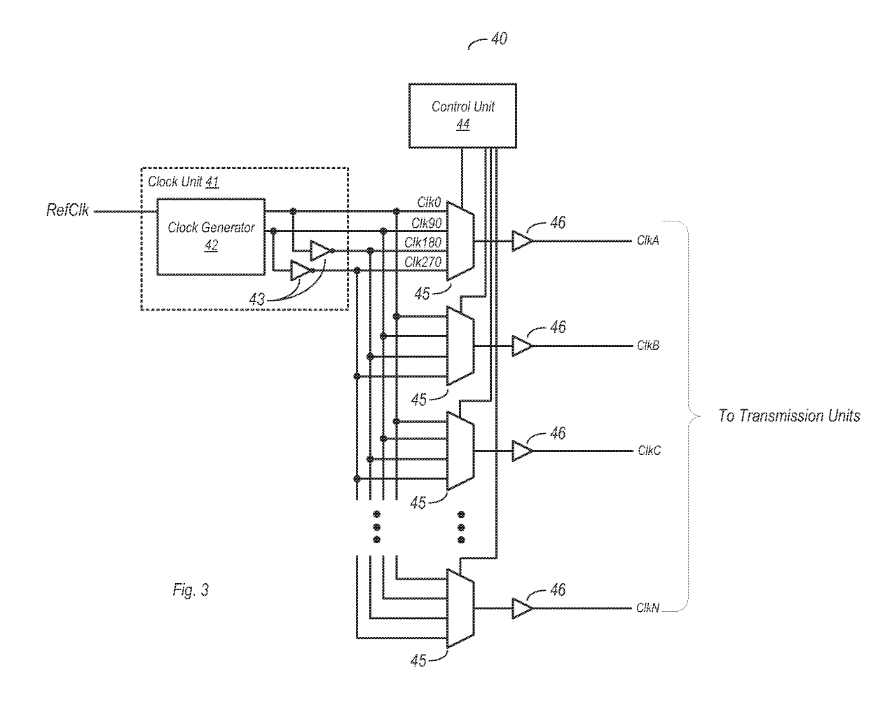

FIG. 3 is a diagram illustrating one embodiment of a clock distribution apparatus used for providing clock signals to one or more pre-emphasis circuits. In the embodiment shown, clock distribution apparatus 40 includes a clock unit 41, a control unit 44, and a number of selection circuits 45. It is noted that some of the various components of clock distribution apparatus 40 may be implemented within other components of graphics subsystem 10. For example, selection circuits 45 may be implemented within particular instances of transmission units 28, while control unit 44 may be implemented within graphics processor 22. Other embodiments may implement these components separately on graphics card 22. In general, the components of clock distribution apparatus may be implemented wherever suitable to perform their intended functions.

Clock unit 41 in the embodiment shown includes a clock generator 42, which is coupled to receive a reference clock signal. Based on the reference clock signal, clock generator 42 may produce two output clock signals, Clk0 and Clk90. These two clock signals may be equal in frequency, while Clk90 may lag (in terms of phase) Clk0 by 90°. Clock generator 42 may be implemented using various types of clock circuitry, including a phase locked loop (PLL), a delay locked loop (DLL), delay circuitry, and any other type of circuit capable of producing two clock signals having a desired phase difference with respect to one another. Clock signals Clk0 and Clk90 may be provided as output clock signals from clock unit 41.

In addition to Clk0 and Clk90, clock unit 41 in the embodiment shown is configured to output two additional clock signals, Clk180 and Clk270. In this embodiment, Clk180 may be produced by inverting Clk0 using a first one of inverters 43. As the name implies, Clk180 has a 180° phase difference with respect to Clk0. A second inverter 43 is coupled to receive Clk90 as an input in order to produce Clk270 as an output. As its name implies, Clk270 differs in phase from Clk0 by 270°.

It is noted that while clock unit 41 in the illustrated embodiment is arranged to output four clock signals differing in phase by 90° increments, other embodiments are possible and contemplated. For example, clock units configured to provide multiple clock signals differing in phase by 45° increments are also possible and contemplated.

Each of the clock signals output by clock unit 41 is provided to each of the selection units 45 in the embodiment shown. Selection units 45 are implemented here as multiplexers configured to select one of the input clock signals to be provided as an output. Each of the selection units 45 may be associated with a corresponding transmission unit, and may provide a selected clock signal thereto via a corresponding buffer 46.

The selection of clock signals received by each instance of transmission unit 28 may be determined by control unit 44. Each selection unit 45 is coupled to receive selection signals from control unit 44. The selection signals received by any particular one of selection units 45 may be independent of those received by the other selection units 45. Accordingly, each selection unit 45 may be independently controlled by control unit 44. In the embodiment shown, each of the three transmission units 28 shown may receive a clock signal that differs in phase with respect to clock signals received by the other two transmission units 28.

In some embodiments, control unit 44 may be implemented as firmware or static hardware, with the generated selection signals remaining unchanged during operation. In other embodiments, control unit 44 may be enabled to change the settings of the selection signals during operation.

### Timing Diagram:

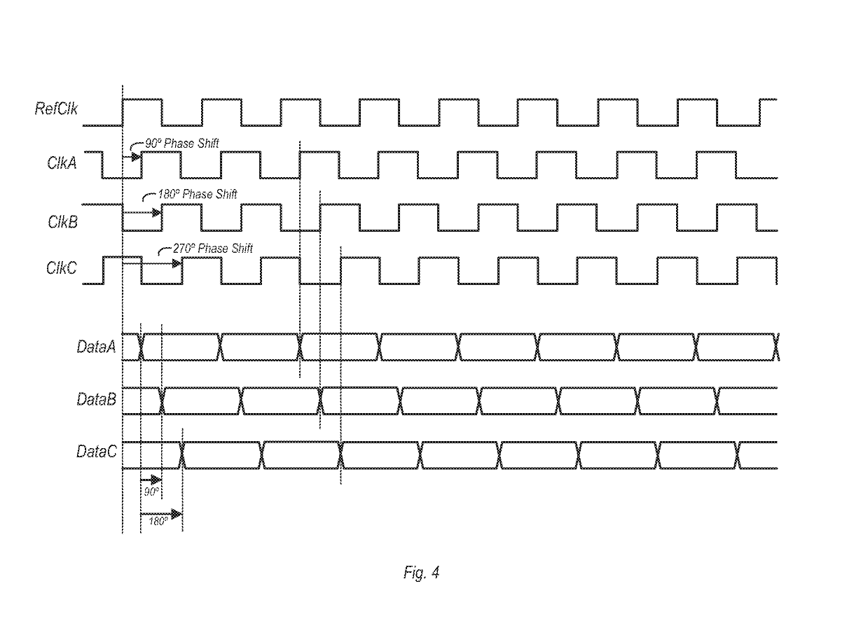

FIG. 4 is a timing diagram illustrating the transmission of skewed signals on a number of physically adjacent channels for one embodiment of a system. The example shown in FIG. 4 illustrates the relationship between clock signals received by respective ones of transmission units 28 as well as the relationship between the data signals transmitted therefrom.

In the upper portion of the drawing, four clock signals are illustrated: a reference clock signal (RefClk), ClkA, ClkB, and ClkC. In this example, ClkA is delayed by from the reference clock signal such that a 90° phase difference (or shift) exists therebetween. ClkB has a 180° phase difference with the reference clock signal, while ClkC has a 270° phase difference with the reference clock signal. Each of clock signals ClkA, ClkB, and ClkC may be received by a respective one of transmission units 28. The transmission unit 28 receiving ClkA may be associated with a transmission line 29 that is physically adjacent to that which receives ClkB. Similarly, the transmission unit 28 that receives ClkB may be physically adjacent to the one that receives ClkC.

The lower portion of the timing diagram illustrates the timing for three different signals, DataA, DataB, and DataC. DataA is associated with ClkA and may be transmitted by the corresponding transmission unit 28 onto the corresponding transmission line 29. Similarly, DataB and DataC are associated with ClkB and ClkC, respectively, as well as their associated transmission units 28 and transmission lines 29.

As can be seen in the diagram, a logical transition of DataA is transmitted at a rising edge of ClkA. A logical transition of DataB is transmitted at a rising edge of ClkB, which lags ClkA by 90°. Thus, the logical transition of DataB lags a logical transition of DataA by 90°, and the signals are skewed relative to one another. A logical transition of DataC lags a logical transition of DataB by 90°, and further lags a logical transition of DataA by 180°. Accordingly, DataC is skewed with respect to both DataA and DataB.

The skewing of signals transmitted on adjacent transmission lines as shown here may reduce EMI generation. The methodology of skewing signals as described herein may provide an alternative to the use of a spread spectrum clock for reducing EMI.

### Method Flow Diagram:

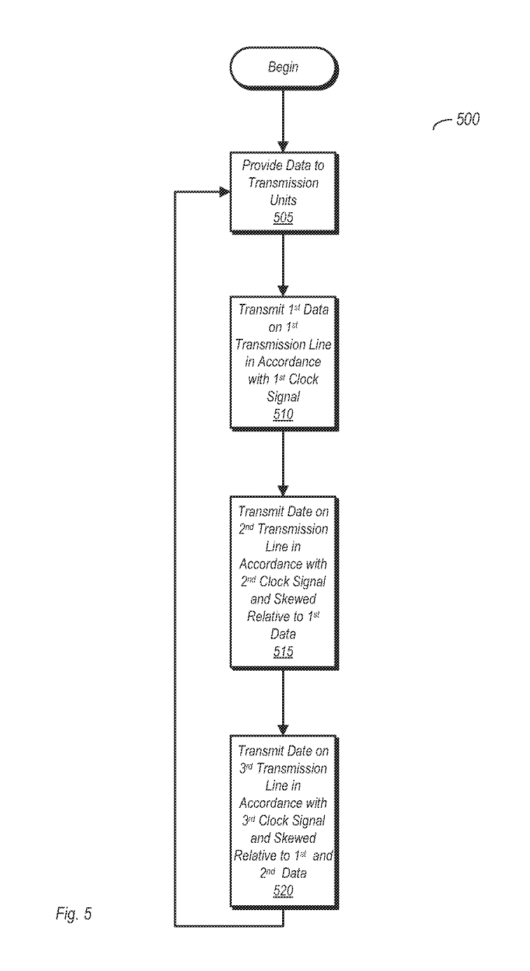

FIG. 5 is a flow diagram illustrating one embodiment of a method for transmitting signals having skew relative to those on adjacent channels. In the embodiment shown, method 500 begins with the providing of data to each of a number of transmission units (block 505). Each of the transmission units receiving data may be timed by a different clock signal.

Method 500 continues with a first transmission unit transmitting first data onto a first transmission line (block 510). Subsequent to transmitting the first data, second data may be transmitted onto a second transmission line (block 515). The second transmission line may be physically adjacent to the first transmission line. Since the second data is transmitted later than the first data, the signals carrying the second data are skewed relative to the signals carrying the first data. Subsequent to transmitting the second data, third data may be transmitted onto a third transmission line (block 520). The third data may be skewed with respect to both the first and second data. The method then returns to block 505 and repeats for each set of bits provided to the respective transmission units. The amount of skew for each signal relative to the other signals may be predetermined, based on the phase difference between the respective clock signals to which their transmissions are synchronized.

### Carrier Medium:

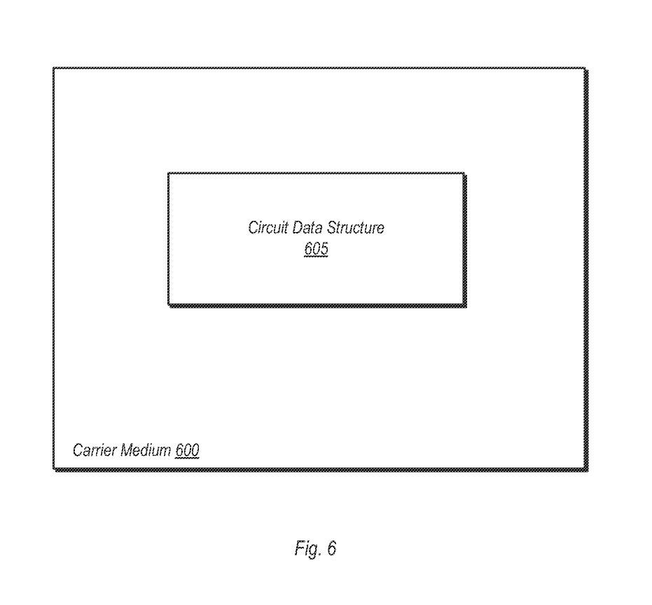

Turning next to FIG. 6, a block diagram of a computer accessible storage medium 600 including a database 605 representative of one or more components of system 10 is shown. Generally speaking, a computer accessible storage medium 600 may include any non-transitory storage media accessible by a computer during use to provide instructions and/or data to the computer. For example, a computer accessible storage medium 600 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Generally, the data 605 representative of the system 10 and/or portions thereof carried on the computer accessible storage medium 600 may be a database or other data structure which can be read by a program and used, directly or indirectly, to fabricate the hardware comprising the system 10. For example, the database 605 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system 10. The netlist may then be placed and routed to produce a data set describing geometric shapes to be applied to masks. The masks may then be used in various semiconductor fabrication steps to produce a semiconductor circuit or circuits corresponding to the system 10. Alternatively, the database 605 on the computer accessible storage medium 600 may be the netlist (with or without the synthesis library) or the data set, as desired, or Graphic Data System (GDS) II data.

While the computer accessible storage medium 600 carries a representation of the system 10, other embodiments may carry a representation of any portion of the system 10, as desired, including graphics card 20, any set of agents (e.g., graphic processor 22, transmission unit 28, clock generator 41, etc.) or portions of agents.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A system comprising:
a plurality of transmission lines, wherein each of the plurality of transmission lines is physically adjacent to at least one other one of the plurality of transmission lines; and
a plurality of transmission units, wherein each of the plurality of transmission units is coupled to a corresponding one of the plurality of transmission lines, wherein each of the plurality of transmission units is configured to transmit a respective signal on its corresponding one of the plurality of transmission lines in accordance with a respectively received one of a plurality of clock signals such that the respective signal is skewed by a predetermined amount with respect to signals transmitted on each adjacent one of the plurality of transmission lines.

2. The system as recited in claim 1, further comprising a clock unit configured to generate the plurality of clock signals, wherein each of the plurality of clock signals has a phase difference with each of the other ones of the plurality of clock signals, and wherein each of the plurality of transmission units is coupled to receive a respective one of the plurality of clock signals.

3. The system as recited in claim 2, further comprising a plurality of selection units each coupled to receive the plurality of clock signals, wherein each of the plurality of selection units is configured to select one of the plurality of clock signals to be provided to a corresponding one of the plurality of transmission units.

4. The system as recited in claim 3, further comprising a control unit coupled to each of the plurality of selection units, wherein the control unit is configured to provide respective selection signals to each of the plurality of selection units such that any two transmission units associated with adjacent ones of the plurality of transmission lines receive clock signals having a phase difference with respect to each other.

5. The system as recited in claim 2, wherein the plurality of clock signals includes:
a first clock signal;
a second clock signal having a 90° phase difference with respect to the first clock signal;
a third clock signal having a 180° phase difference with respect to the first clock signal; and
a fourth clock signal having a 270° phase difference with respect to the first clock signal.

6. The system as recited in claim 2, wherein each of the plurality of transmission units includes a flop circuit coupled to receive one of the plurality of clock signals.

7. The system as recited in claim 6, wherein each of the plurality of transmission units further includes:
a serializer coupled to provide a serial stream of data to the flop circuit;
a buffer coupled to an output of the flop circuit, wherein the buffer is coupled to a corresponding one of the plurality of transmission lines.

8. The system as recited in claim 6, wherein a flop circuit of a first one of the plurality of transmission units is configured to operate based on a first clock signal, wherein a flop circuit of a second one of the plurality of transmission units is configured to operate based on a second clock signal having a phase difference with respect to the first clock signal.

9. The system as recited in claim 8, wherein a flop circuit of a third one of the plurality of transmission units is configured to operate based on a third clock signal having a phase difference with respect to at least one of the first and second clock signals.

10. The system as recited in claim 9, wherein the first and second clock signals have a phase difference of 90° with respect to each other, and wherein the second and third clock signals have a phase difference of 90° with respect to each other.

11. A method comprising:
a plurality of transmission units transmitting signals on a plurality of transmission lines, wherein each of the plurality of signal lines is physically adjacent to at least one other one of the plurality of signal lines, the plurality of transmission units including a first transmission unit and a second transmission unit, wherein said transmitting signals includes:
the first transmission unit transmitting, on a first one of the plurality of transmission lines, a first signal in accordance with a respectively received one of a plurality of clock signals;
the second transmission unit transmitting, on a second one of the plurality of transmission lines that is physically adjacent to the first one of the plurality of transmission lines in accordance with a respectively received different one of the plurality of clock signals, a second signal having a first predetermined amount of skew relative to the first signal.

12. The method as recited in claim 11, further comprising a third one of the plurality of transmission units of the transmitting, on a third transmission line adjacent to the second transmission line, a third signal with a second predetermined amount of skew relative to the first signal.

13. The method as recited in claim 12, further comprising:
a clock unit providing the plurality of clock signals to each of a plurality of selection circuits, wherein each of the plurality of clock signals has a phase offset with respect to every other one of the plurality of clock signals; and
each of the plurality of selection circuits providing a selected one of the plurality of clock signals to a corresponding one of the plurality of transmission units.

14. The method as recited in claim 13, further comprising a control unit causing a first one of the selection circuits to select a first one of the plurality of clock signals to be provided to the first transmission unit, a second one of the plurality of clock signals to be provided to the second transmission unit, and a third one of the plurality of clock signals to be provided to the third transmission unit, wherein the first, second, and third ones of the plurality of clock signals are offset in phase with respect to one another.

15. The method as recited in claim 13, wherein the plurality of clock signals includes:
a first clock signal;
a second clock signal having a 90° phase shift with respect to the first clock signal;
a third clock signal having a 180° phase shift with respect to the first clock signal; and
a fourth clock signal having a 270° phase shift with respect to the first clock signal.

16. The method as recited in claim 13, further comprising a respective flop circuit of each of the plurality of transmission units receiving a respective one of the plurality of clock signals.

17. The method as recited in claim 16, further comprising:
a serializer of each of the plurality of transmission units providing a serial stream of digital data to a respective flop circuit;
a buffer of each of the plurality of transmission units receiving the serial stream of digital data from the respective flop circuit; and
the buffer driving each bit of the serial stream of digital data onto a respective one of the plurality of transmission lines.

18. The method as recited in claim 13, wherein a selected one of the plurality of clock signals received by the second transmission unit has a 90° phase offset with respect to a selected one of the plurality of clock signals received by the first transmission unit, and wherein a selected one of the plurality of clock signals received by the third transmission unit has a 90° phase offset with respect to a selected one of the plurality of clock signals received by the second transmission unit.

19. The method as recited in claim 12, further comprising:
a receiver receiving signals transmitted from the first, second, and third transmission units;
translating the signals received by the receiver into information displayed on a display unit.

20. A graphics subsystem comprising:
a graphics processor configured to generate graphics information; and
a plurality of transmission units coupled to receive the graphics information from the graphics processor, wherein each of the plurality of transmission units is configured to, in accordance with a respectively received one of a plurality of clock signals, transmit signals based on the graphics information onto one of a plurality of physically adjacent transmission lines, wherein the plurality of transmission units includes:
a first transmission unit configured to transmit a first plurality of signals onto a first one of the plurality of transmission lines; and
a second transmission unit configured to transmit a second plurality of signals onto a second one of the plurality of transmission lines, the second one of the plurality of transmission lines being physically adjacent to the first one of the plurality of transmission lines, wherein each of the second plurality of signals has a predetermined skew relative to each of the first plurality of signals.

21. The graphics subsystem as recited in claim 20, wherein the plurality of transmission units further includes a third transmission unit configured to transmit a third plurality of signals onto a third one of the plurality of transmission lines, the third one of the plurality of transmission lines being physically adjacent to the second one of the plurality of transmission lines, wherein each of the third plurality of signals has a predetermined skew relative to each of the second plurality of signals.

22. The graphics subsystem as recited in claim 21, wherein each of the third plurality of signals has a predetermined skew relative to each of the first plurality of signals.

23. The graphics subsystem as recited in claim 22, wherein each of the first, second, and third pluralities of signals comprises a serial stream of digital data.

24. The graphics subsystem as recited in claim 21, wherein the graphics subsystem further includes:
a clock unit configured to generate the plurality of clock signals, wherein each of the plurality of clock signals has a phase difference with each of the other ones of the plurality of clock signals;
a plurality of selection units each coupled to receive the plurality of clock signals, wherein each of the plurality of selection units is configured to select one of the plurality of clock signals to be provided to a corresponding one of the plurality of transmission units;
a control unit configured to provide selection signals to each of the plurality of selection units such that each of the first, second, and third transmission units receives a respective clock signal having a phase difference with respect to the clock signals received by the other ones of the first, second, and third transmission units.

25. The graphics subsystem as recited in claim 24, wherein the plurality of clock signals includes:
a first clock signal;
a second clock signal having a 90° phase difference with respect to the first clock signal;
a third clock signal having a 180° phase difference with respect to the first clock signal; and
a fourth clock signal having a 270° phase difference with respect to the first clock signal.

26. The graphics subsystem as recited in claim 21, wherein each of the plurality of transmission units includes:
a serializer coupled to receive information from the graphics processor and configured to output a serial stream of data;
a flop circuit coupled to receive a clock signal and the serial stream of data, wherein the flop circuit is configured to convey the serial stream of data in accordance with the clock signal; and
a buffer unit coupled to receive the serial stream of data from the flop circuit and configured to convey the serial stream of data onto a respective one of the plurality of transmission lines.

27. The graphics subsystem as recited in claim 26, further comprising a display unit coupled to receive data from each of the plurality of transmission units via the plurality of transmission lines, wherein the display unit is configured to convert the received data into information to be displayed.

28. A non-transitory computer readable medium comprising a data structure which is operated upon by a program executable on a computer system, the program operating on the data structure to perform a portion of a process to fabricate an integrated circuit including circuitry described by the data structure, the circuitry described in the data structure including:
a plurality of transmission lines, wherein each of the plurality of transmission lines is physically adjacent to at least one other one of the plurality of transmission lines; and
a plurality of transmission units, wherein each of the plurality of transmission units is coupled to a corresponding one of the plurality of transmission lines, wherein each of the plurality of transmission units is configured to transmit, in accordance with a respectively received one of a plurality of clock signals, a respective signal on its corresponding one of the plurality of transmission lines, and wherein each of the plurality of transmission units is configured to transmit a respective signal on its corresponding transmission line that is skewed by a predetermined amount with respect to signals transmitted on each adjacent one of the plurality of transmission lines.

29. The computer readable medium as recited in claim 28, further comprising a clock unit configured to generate a plurality of clock signals, wherein each of the plurality of clock signals has a phase difference with each of the other ones of the plurality of clock signals, and wherein each of the plurality of transmission units is coupled to receive a respective one of the plurality of clock signals.

30. The computer readable medium as recited in claim 28, wherein the data structure comprises one or more of the following types of data:
HDL (high-level design language) data;
RTL (register transfer level) data;
Graphic Data System (GDS) II data.
